(19) United States
(12) Patent Application Publication
(10) Pub. No.: US 2007/0107512 A1
(43) Pub. Date: May 17, 2007

(54) Flow state observation device and flow state observation method

(75) Inventor: Tadao Okazaki, Hamamatsu-shi (JP)

Correspondence Address: Yokoi & Co., U.S.A., Inc., 13700 Marina Pointe Drive #723, Marina Del Rey, CA, 90292, US

(73) Assignee: OHM ELECTRIC CO., LTD., Shizuoka (JP)

(21) Appl. No.: 11/648,997

(22) Filed: Jan. 3, 2007

Related U.S. Application Data
(63) Continuation of application No. PCT/JP05/24074, filed on Dec. 28, 2005.

(30) Foreign Application Priority Data
Mar. 23, 2005 (JP) JP2005-083784

(51) Int. Cl. G01F 1/68; G01F 1/00

(52) U.S. Cl. 73/204.23; 73/861

(57) ABSTRACT

The present invention discloses a device for observing a flow state comprising a translucent duct. It further comprises an irradiation unit irradiating projection light, a condensing unit condensing the projection light along a length direction with respect to an axial core area of the translucent duct in which a fluid flows; and an image pickup unit for picking up images of scattered reflected light from an axial core area of the translucent duct at a plurality of times.

### CROSS-REFERENCES TO RELATED APPLICATIONS

This application claims the benefit of priority and is a Continuation application of the prior International Patent Application No. PCT/JP2005/024074, with an international filing date of Dec. 28, 2005, which designated the United States, and is related to the Japanese Patent Application No. 2005-083784, filed Mar. 23, 2005, the entire disclosures of all applications are expressly incorporated by reference in their entirety herein.

### BACKGROUND OF THE INVENTION

(1) Field of the Invention

The present invention relates to a flow state observation device and a flow state observation method.

(2) Description of Related Art

In recent years, the excess supply of lubricating oil has been identified as an issue posed to zero emission activities in machining plants and there exists a need for robust measurement tools with a resolution on the order of 10 μL (liters)/h for the purpose of quantitatively grasping and managing the amount of lubricating oil.

It has previously been possible to meet such a need by establishing a minute flow path in order to attempt an increase in the flow rate and measuring the duct resistance as a pressure difference.

However, with the conventional technique mentioned above, because correction of the fluid viscosity that fluctuates markedly with respect to temperature is necessary and there is a danger of the flow path being blocked, the technique is confined to the experimental device stage and does not satisfy requirements for FA (Factory Automation) site measurement tools. Further, the supply of a minute flow volume is generally implemented by intermittently driving a driving element such as a diaphragm or valve or the like in a pump or the like. There has also been the problem that the flow state of a fluid of a minute volume is complex and observation of this flow state is difficult.

### BRIEF SUMMARY OF THE INVENTION

The present invention discloses a device for observing a flow state, comprising: a translucent duct; an irradiation unit irradiating projection light; a condensing unit condensing the projection light along a length direction with respect to an axial core area of the translucent duct in which a fluid flows; and an image pickup unit for picking up images of scattered reflected light from an axial core area of the translucent duct at a plurality of times.

An optional aspect of the present invention provides a device for observing a flow state, further comprising: a computation unit for calculating a flow rate of the fluid on the basis of the image at a plurality of times.

Another optional aspect of the present invention provides a device for observing a flow state, wherein: the fluid is a saturated fluid that flows in the duct and the flow volume of the saturated fluid is calculated on the basis of the flow rate and a cross-sectional area of the duct.

An optional aspect of the present invention provides a device for observing a flow state, wherein: the fluid is an unsaturated fluid that flows in the duct and the flow volume of the unsaturated fluid is calculated on the basis of the flow rate and an attenuation volume of the transmitted light that is transmitted via the translucent duct.

Another optional aspect of the present invention provides a device for observing a flow state, wherein: the fluid is an unsaturated fluid that flows in the duct and the flow volume of the unsaturated fluid is calculated on the basis of the flow rate and the scattered light amount scattered in the translucent duct.

An optional aspect of the present invention provides a device for observing a flow state, wherein: the irradiation unit comprises a semiconductor laser and a PWM control circuit that controls an output of the semiconductor laser.

Another optional aspect of the present invention provides a device for observing a flow state, wherein: the image pickup unit comprises a CCD line sensor.

An optional aspect of the present invention provides a device for observing a flow state, wherein: the computation unit applies a spatial frequency filter to the image pickup images picked up by the CCD line sensor.

Another optional aspect of the present invention provides a device for observing a flow state, wherein: the computation unit multiplies a weighting function as the spatial frequency filter to outputs of the CCD line sensor.

An optional aspect of the present invention provides a device for observing a flow state, wherein: the computation unit multiplies a sine function as the weighting function.

Another optional aspect of the present invention provides a device for observing a flow state, wherein: the computation unit multiplies a rectangular wave function as the weighting function.

An optional aspect of the present invention provides a device for observing a flow state, wherein: the image pickup is performed by mixing particles of different optical properties that increase the reflected light of the projection light with the fluid.

Another optional aspect of the present invention provides a device for observing a flow state, wherein: the image pickup unit is disposed in a direction in which a reflected light component from the translucent duct is large.

An optional aspect of the present invention provides a device for observing a flow state, further comprising: an output unit for visually outputting the images at a plurality of times.

Another optional aspect of the present invention provides a device for observing a flow state, further comprising: a spatial frequency analysis unit for acquiring the images picked up by the CCD line sensor that are picked up at different times and for acquiring a spatial frequency spectral that relates to the axial core direction of the images while moving the images relatively in the axial core direction; and a flow rate calculation unit for calculating the flow rate of the fluid on the basis of a relative movement amount of the image pickup images when a correlation between the images and the spatial frequency spectral is enhanced.

An optional aspect of the present invention provides a device for observing a flow state, the spatial frequency analysis unit multiplies a window function obtained by shifting the relative position in the axial core direction with respect to the images.

Another optional aspect of the present invention provides a device for observing a flow state, the spatial frequency analysis unit multiplies a sine function as the window function.

An optional aspect of the present invention provides a device for observing a flow state, the fluid is an unsaturated fluid that flows in the duct and the flow volume of the unsaturated fluid is estimated on the basis of an index value obtained by multiplying together a value obtained by integrating the intensity of the spatial frequency spectral and the flow rate.

The present invention discloses a method for observing a flow state, comprising: a method for observing a flow state, comprising: condensing projection light at an axial core of a translucent duct; and performing image pickup on an axial core area at a plurality of times.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary schematic diagram of a flow state observation device according to an embodiment of the present invention;

FIG. 2 is an exemplary schematic diagram of when the flow state observation device is viewed from a different viewpoint;

FIG. 3 shows an exemplary disposition of the coordinate axis of a translucent duct;

FIG. 4 shows an exemplary velocity distribution of the laminar flow in the translucent duct;

FIG. 5 shows an exemplary application of a weighting coefficient to the output signal of a CCD line sensor;

FIG. 6 is an exemplary schematic constitutional view of the flow state observation device of a third embodiment;

FIG. 7 shows an exemplary output example of image pickup images which are arranged to permit a comparison;

FIG. 8 is an exemplary constitutional view of the essential parts of the flow state observation device of a fourth embodiment;

FIG. 9 shows an exemplary aspect in which the image pickup images are moved;

FIG. 10 is an exemplary graph showing a spatial frequency spectral; and

FIG. 11 is an exemplary graph showing a correlation coefficient.

### DETAILED DESCRIPTION OF THE INVENTION

The detailed description set forth below in connection with the appended drawings is intended as a description of presently preferred embodiments of the invention and is not intended to represent the only forms in which the present invention may be constructed and/or utilized.

### (A) First Embodiment

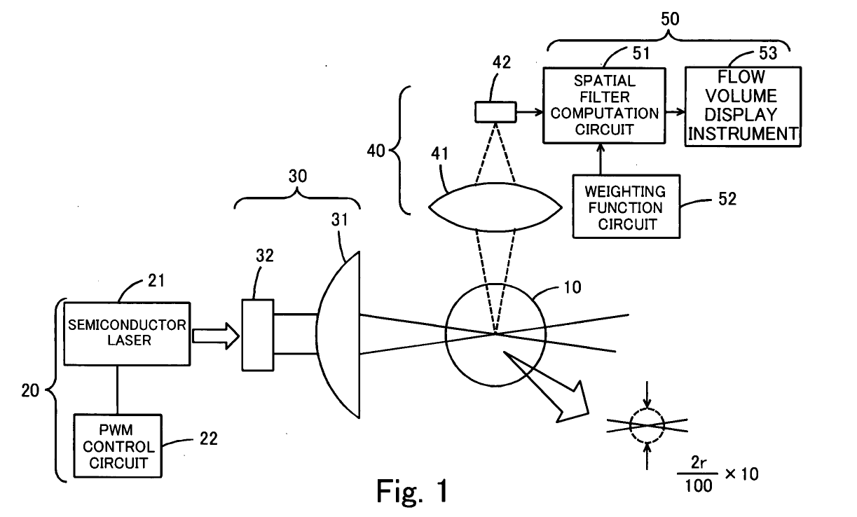

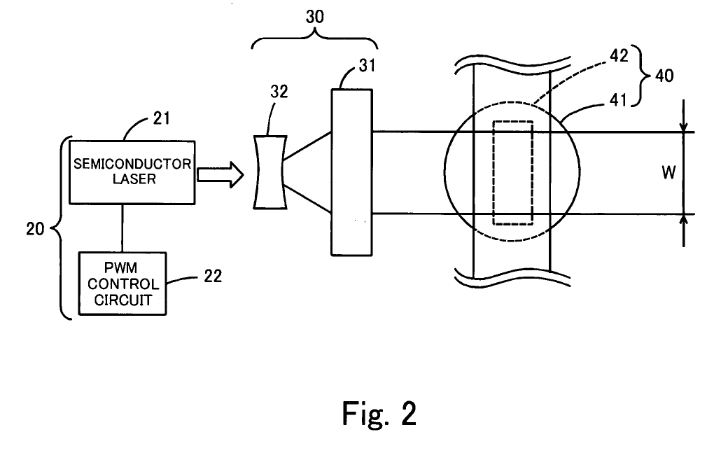

A first embodiment of the present invention will be described hereinbelow based on the drawings. FIGS. 1 and 2 provide exemplary schematic views of a flow state observation device of the first embodiment of the present invention. FIG. 1 shows an exemplary disposition state of the duct as viewed from the axial core direction and shows the disposition state as viewed from a direction orthogonal to the axial core of the duct. The translucent duct 10 is made of transparent glass and is translucent and therefore constitutes a translucent duct. The translucency corresponds to the quality and wavelength of the projection light but there is not necessarily a need for translucency to the naked eye. The whole of the duct can be covered as long as the required optical path is secured.

The semiconductor laser 21 projects laser light of a predetermined intensity as a result of a driving power supply being supplied by a PWM (Pulse Width Modulation) control circuit 22. Hence, projected light irradiating means 20 is constituted by the semiconductor laser 21 and the PWM control circuit 22. The semiconductor laser 21 is constituted by a diode laser and an optional light amount can be created while providing high-responsiveness by the PWM control circuit 22 that controls the composition ratio between the light emission time and the light extinction time. The translucent duct 10 has a translucent function with respect to the laser of the semiconductor laser 21.

A first optical system 30 comprises a cylinder lens 31, a concave lens 32 and a convex lens that is not illustrated. This first optical system 30 forms an optical path to condense light as an axial core while expanding the projection light irradiated by the semiconductor laser 21 along the axial core direction with respect to the translucent duct 10. In other words, the laser is condensed as an axial core and transmitted over a fixed length of the translucent duct 10. This means that the first optical system 30 constitutes projection light condensing means. Here, ‘axial core’ indicates substantially 10% of the diameter as will be described subsequently. The aim of the axial core will be described subsequently.

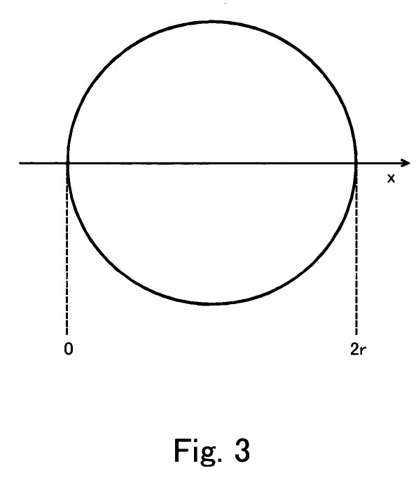

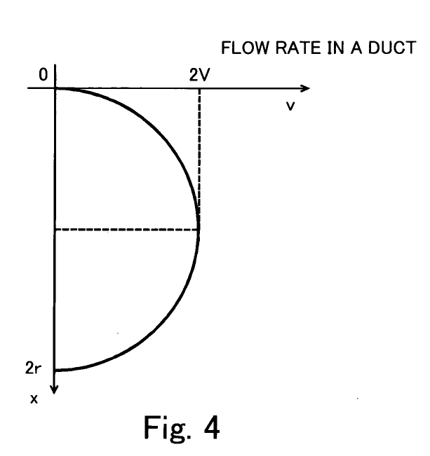

FIG. 3 shows an exemplary relationship between the flow rate and position in the translucent duct 10. FIG. 4 shows an exemplary method of measuring the position in the translucent duct 10. Now, when a coordinate axis that extends from one inside wall (0) to the opposite inside wall (2r) is formed so as to pass through the center of the translucent duct 10 of radius r as shown in FIG. 4, the flow rate of the respective coordinate positions is 0 to 2V (V is the average flow rate) as shown in FIG. 3 in the case of laminar flow within the translucent duct 10. The range in which the flow rate is from 2V to 1.98V, that is, a range within 1%, is a range of approximately 10% with respect to the shaft diameter (diameter) (a range of diameter 2r/100). An average flow rate V is determined with practical accuracy by measuring the flow rate in an axial position within this range of approximately 10%. Hence, the range of the axial core to be condensed by the first optical system 30 is a range of approximately 10% that includes the axial center in which the flow rate of the laminar flow is stabile. Naturally, the range to be condensed in accordance with the accuracy thus determined can be changed.

On the other hand, the length (W) of expansion along the axial core direction changes depending on the type of parameters. The parameters are the flow rate and the resolution of the image pickup means and so forth. When the laser passes through the translucent duct 10, a second optical system 41 is an optical system for performing photography by providing an image of an aspect rendered through the scattering of particles having different optical properties in the axial core area on a CCD (Charge Coupled Device) line sensor 42 which is an image pickup element. Naturally, the optical axis of the projection light projected by the first optical system 30 and the optical axis of the second optical system 41 do not coincide and a target that is imaged by the second optical system 41 is not present unless there is no scattered light.

The CCD line sensor 42 is a line sensor in which CCDs are disposed in a row within a predetermined range. The CCD line sensor 42 outputs electric charge that corresponds to the irradiated light amount. An image of the axial core area of the translucent duct 10 is provided on the respective cells of the CCD line sensor 42 by the second optical system 41 and, when light amounts are obtained on the basis of the output signal of the CCD line sensor 42, an image of the same axial core area can be reproduced. The image of the axial core area is used to obtain a flow rate component on the basis of a spatial frequency filter. Hence, the use of other image pickup elements that achieve this object is also possible. Further, axial imaging means 40 that performs image pickup in cycles while contrast-enhancing the reflected light from the axial core area of the translucent duct 10 in predetermined positions in the length direction by means of the second optical system 41 and CCD line sensor 42.

The output signal of the CCD line sensor 42 is input to a spatial filter computation circuit 51. Generally, the computation of the flow rate component that uses a spatial filter is performed by using the following equations:
F=mV1/p1
V1=p1·F/m
(where V1 is the velocity, p1 is the pitch of the spatial filter, and m is the optical imaging amplification).

The spatial filter provides spatial frequency selectivity and the CCD line sensor 42 that comprises photocells with a predetermined pitch satisfies the conditions for establishing the narrowband spatial filter. Accordingly, the relative velocity V1 can be determined on the basis of the pitch and the frequency signal of the CCD line sensor 42.

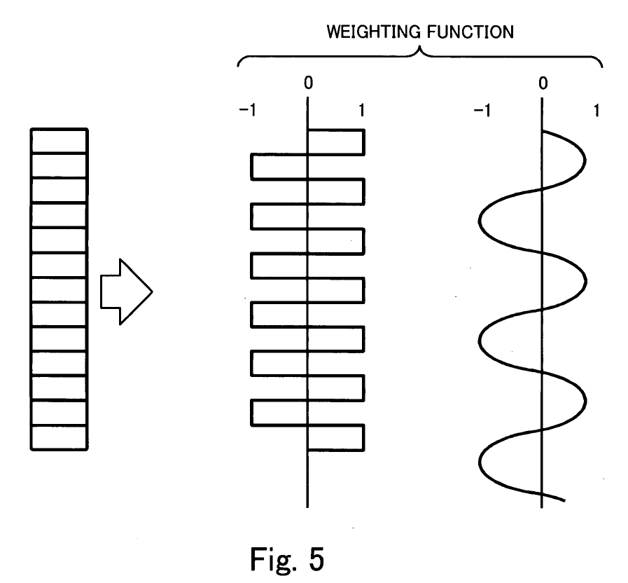

The CCD line sensor 42 has a fixed pitch. However, because the output signals of the CCD line sensor 42 each correspond to independent light amounts for each cell, the characteristics of the spatial filter can be varied by superimposing a weighting function shown in FIG. 5 on the output signal. Hence, by producing weighting functions that are adapted to the measurement target and measurement environment of the weighting function circuit 52, the range of the measurement target can be freely expanded. Naturally, the spatial frequency selectivity corresponding with the state can also be provided by applying the Hanning function or the like.

The spatial filter computation circuit 51 establishes a predetermined photography cycle and successively obtains the output signals of the CCD line sensor 42. Computation source data are obtained as a progression of the values of the output signals at the respective timings and superimposed as a preset weighting function on the computation source data (multiplied thereby). Post-computation data are then obtained as a time series from values rendered by performing integration in predetermined sections on the respective products of the multiplication. Because the post-computation data are functional values for which an increase is repeated with a predetermined cycle, a velocity component is determined by multiplying the pitch and the inverse of the imaging magnification with this frequency.

In the case of an infinitesimal flow volume to an ultra-low velocity flow to which the present invention is directed, the frequency in the above description is very low. Hence, in a conventional technique that simply performs addition, a very long addition time is required and the technique is not practical. Therefore, in this specification, a shortening of the addition time can be implemented by establishing a plurality of weighting functions the phases of which are shifted by equal amounts by extending the zero crossing points to fixed intervals and adding, with the zero crossing points for multiple function groups extended to fixed intervals values chronologically for each weighting function, values that are computed for each weighting function for the output of the CCD cells. Alternatively, frequency values can be obtained for each practical time as a result of measuring the cycles of the zero crossing points thus found.

The velocity component determined by the spatial filter computation circuit 51 is two times (2V) the average velocity and a flow volume display instrument 53 multiplies the predetermined cross-sectional area of the translucent duct 10 by the average velocity V and finds and displays the flow volume per unit time.

The spatial filter computation means 50 are constituted by the spatial filter computation circuit 51 that executes the computation processing of the output signals of the CCD line sensor 42, the weighting function circuit 52, and the flow volume display instrument 53. Naturally, the flow volume display instrument 53 is not required as far as finding only the velocity component goes.

The operation of this embodiment with the above constitution will be described next.

Suppose that a liquid such as machine lubricant, for example for which the flow rate is to be measured is flowing through a predetermined duct. By interposing the translucent duct 10 in the same duct, the same machine lubricant passes through the translucent duct 10. Essentially, the machine lubricant comprises a uniform translucent component and particles do not exist. Therefore, at first glance, the machine lubricant is only a colorless or light-colored transparent liquid.

The semiconductor laser 21 repeatedly turns ON and OFF at the ON and OFF times set by the PWM control circuit 22 and emits laser light which amounts to a predetermined light amount overall. The laser light enters the first optical system 30 where it is extended to assume a width W in the axial core direction of the translucent duct 10 and condensed to pass through the center of the translucent duct 10 at this width before being emitted.

The laser light passes through the machine lubricant that flows inside the translucent duct 10. Normally, there is a tendency to consider that scattered light will not be produced even when laser light passes through the machine lubricant that is supposed to be uniformly transparent. However, it is, conversely, rare that particles with different optical properties will be entirely non-existent; scattered light is produced by a small quantity of particles with different optical properties. The direction component of the scattered light is random. However, there are also many instances where the light emission source of the laser light has a larger amount of scattered light on average than in the direction of transmittance of the laser light. Hence, the optical axis of the second optical system 41 may be established at an acute angle (less than 90 degrees) to the optical axis of the first optical system 30 depending on the amount of light.

The scattered light produced by the particles of different optical properties that exist in the translucent duct 10 also enters the second optical system 41 and an image of the axial core of the translucent duct 10 is provided on the CCD line sensor 42 by the second optical system 41.

Electric charge is deposited on each cell in accordance with the amount of light formed on the CCD line sensor 42. Here, the spatial filter is established as a narrowband spatial filter in accordance with the disposition of each cell. The spatial filter computation circuit 51 acquires the output signals of the CCD line sensor 42 at each predetermined time. The output signals of the CCD line sensor 42 thus correspond to an image rendered to which a spatial filter is applied to produce the computation source data. Although the frequency thereof may be obtained as is, because the flow rate is slow, the frequency obtained should be amplified by multiplying by a sine function with a frequency that corresponds with the amplification ratio applied a spatial phase difference.

Further, by performing sequential integration within a predetermined range on signal values that correspond with output signals which are input chronologically, representative values for the respective time series are found. The representative values are computed data and the frequencies represented by the computed data are superimposed signals that correspond to the multiplier. By dividing the spatial frequency thus determined by the multiplier, the spatial filter computation circuit 51 determines the average velocity V. Naturally, the spatial filter computation circuit 51 is also capable of the task of finding the frequency by means of a frequency analysis technique such as the commonly known FFT with respect to a time-series computed data array.

The flow volume display instrument 53 then multiplies the average velocity V by the cross-sectional area of the translucent duct 10 and displays the flow rate per unit of time. In the above embodiment, particles with different optical properties need not be mixed with the machine lubricant which is the target of measurement and measurement is performed only by means of particles with different optical properties that exist naturally. Although the required scattered light is obtained by means of particles with different optical properties, the scattered light is insufficient when the amount of light of the semiconductor laser 21 is inadequate or when the translucency of the machine lubricant is low. Furthermore, in some instances, the noise component is large due to the inadequacy of the amount of light and the measurement accuracy does not satisfy the required accuracy. In such a case, it is sufficient to mix particles with different optical properties for which there is no fundamental drop in performance with the machine lubricant. Minute air bubbles may be given as a suitable example of this type of particles with different optical properties. The minute air bubbles do not have different components added thereto and are suitable for the present invention which requires scattered reflected light due to their long residual time.

That is, scattered light is readily produced by implementing a pseudo increase in the amount of particles with different optical properties and image pickup by the axial core pickup means is straightforward and the SN ratio of the image can be increased. Thus, based on the reality that even when a fluid is uniform and does not appear to produce scattered light, there are no fluids that are actually homogeneous and in which particles with different properties do not exist, when laser light is made to pass through a translucent duct and condensed to extend in the length direction in an axial core area of a predetermined region of the transmission path, image pickup can be performed by the CCD line sensor 42 as a result of scattered light being produced by particles with different properties in the axial core area and a velocity component that uses a spatial filter can be computed by performing a predetermined operation. Hence, the average flow rate and flow volume and so forth can be determined on the basis of the laminar flow in the translucent duct 10.

In the above process, the flow volume is calculated with respect to the saturated flow with which the fluid fills the duct and the flow volume is found by multiplying the average flow rate thus determined by the cross-sectional area. In contrast, when the flow volume of an unsaturated fluid having multiple flows of atomized oil particles in an air is specified, the fluid volume per unit length cannot be specified by only the cross-sectional area.

However, by finding the density per unit length separately, the flow volume can be also obtained for the unsaturated fluid if the average flow rate is multiplied by the density of the fluid. For example, when the density of the oil particles exposed in the fluid is measured, the unsaturated fluid flowing in the translucent duct 10 is trapped at predetermined times and, by measuring the weight and volume and so forth of the trapped oil, the density of the oil particles can be measured. Further, in instances where the atomization rate when the oil particles are atomized in the air is specified, the density of the oil particles can also be specified from the atomization rate. The flow volume of the unsaturated fluid flowing in the translucent duct 10 can also be calculated by multiplying the density of the unsaturated fluid obtained as detailed above by the average flow rate.

### (B) Second Embodiment

With the embodiment above, because there is the possibility that the density will fluctuate at the point where the unsaturated fluid flowing in the translucent duct 10 is trapped and at the point where the flow rate is measured, when the density of the unsaturated fluid is unstable, the correct flow volume cannot be measured. Further, there are many cases where the atomization rate does not stabilize and there has been the problem that it is difficult to estimate the exact density at the point where the exact flow rate is measured from the atomization rate. Therefore, in the second embodiment, the above problem is solved by measuring the density of the unsaturated fluid at the same time as measuring the flow rate of the unsaturated fluid flowing in the translucent duct 10.

In the present invention, laser light is irradiated by the semiconductor laser 21 onto the translucent duct 10 and the density of the unsaturated fluid can be measured in real time by using the laser light. For example, when oil particles that have been atomized in the air are an unsaturated fluid, because the optical properties of the air and oil particles differ, the density can be measured by observing the laser light that passes through the translucent duct 10. The air can be considered to transmit the light substantially without reflecting the light and it can be said that, when the density of the oil particles is low, the amount of transmitted laser light increases. On the other hand, because the oil particles are opaque, it can be said that the amount of transmitted laser light is attenuated when the density of the oil particles is high. In addition, because the oil particles have a high refractive index than that of air, it can be said that the amount of scattered light resulting from the laser light being reflected by the oil particles increases when the density of the oil particles is high.

In other words, because it can be said that there is an unambiguous relationship between the amount of transmitted laser light (attenuation amount), the scatter light amount, and the density of the gas particles, by pre-examining this relationship, it is possible to obtain the density of the corresponding oil particles from the amount of transmitted laser light or the scattered light amount during flow rate measurement. Further, for detecting the transmitted light amount, it is sufficient to install a light intensity sensor like that of the CCD line sensor 42 on the optical axis of the semiconductor laser 21 so that laser light penetrating the translucent duct 10 can be received. If the amount of transmitted light is obtained, the amount of attenuation of the laser light in the translucent duct 10 can be obtained from the amount of light that is output of the original laser light. Further, because the CCD line sensor 42 is displaced from the optical axis of the semiconductor laser 21, the amount of scattered light can be detected by using the output signal of the CCD line sensor 42 and there is no need to add a new device. Irrespective of the technique used, because the density can be specified with the same timing as the timing for measuring the flow rate, the exact flow volume can be measured even when the atomization rate and density or the like are unstable.

### (C) Third Embodiment

Generally speaking, in cases where a minute flow volume is generated, because the pressure difference is excessive when the actuators are driven continuously, the actuators are operated intermittently. In such cases, the flow of the fluid is extremely complicated depending on the drive timing of each actuator. That is, in addition to the flow rate fluctuating over time, depending on the case, there is sometimes a counter current. In such a case, if the flow state can be grasped visually in addition to numerical values referring to the flow rate and flow volume, it is possible to accurately grasp the flow state of a fluid of a minute flow volume.

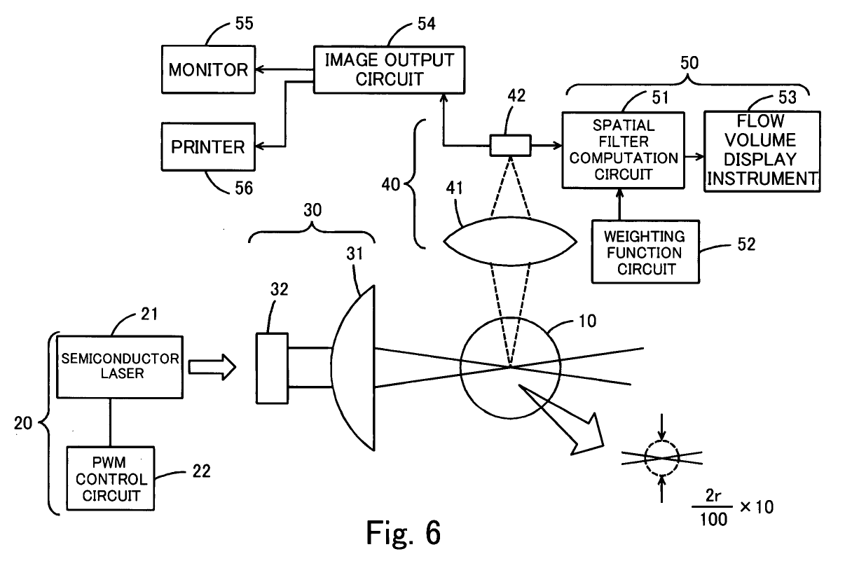

FIG. 6 shows an exemplary schematic constitution of a flow state observation device according to the third embodiment. In FIG. 6, an image output circuit 54 is additionally connected to the CCD line sensor 42 and the image output circuit 54 is connected to a monitor 55 and printer 56 that correspond to the output means of the present invention. As detailed earlier, the output signals of the CCD line sensor 42 signify the image pickup images of the axial core area of the translucent duct 10 and respective pixels that are arranged in a line shape are one-dimensional image data that have brightness levels that correspond with the reflection light amounts reflected by particles of different optical properties that exist in the corresponding positions. The CCD line sensor 42 outputs one-dimensional image pickup data to the image output circuit 54. The image output circuit 54 comprises a memory (not illustrated) and sequentially stores the image data. The image output circuit 54 then outputs image data to each of the monitor 55 and printer 56 on the basis of the sequentially stored image pickup image data.

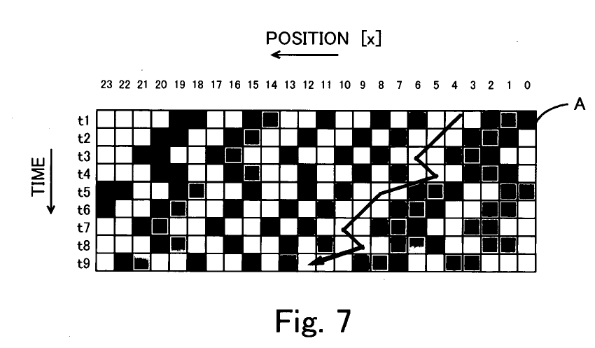

FIG. 7 shows a simplified example of an image that is output by the monitor 55 and printer 56. In FIG. 7, a rectangular image A is displayed; the vertical axis of image A represents time and the horizontal axis of image A represents the position (x) in the axial core direction of a pixel. Further, this means that, the lighter the pixel color is, the larger the light reception amount of the CCD element at the corresponding address and the thicker the pixel color is, the smaller the light reception amount of the CCD element at the corresponding address. FIG. 7 shows an exemplary simplified version of image A. In reality, an image at the resolution corresponding to the number of pixels of the CCD line sensor 42 is displayed.

In image A, one-dimensional images of the respective times that are sequentially output by the CCD line sensor 42 are arranged successively with time. In this kind of image A, when one time is considered, it is possible to visually grasp the fact that particles with different optical properties are distributed in particular positions in the axial core area of the translucent duct 10. In addition, by tracking dense pixels spanning a plurality of times, it is possible to visually grasp the positions of the particles with different optical properties as time elapses.

It can be seen from image A that particles with different optical properties move to the left in the axial core direction as time elapses. For example, when the locus of the dense pixels rises to the right, it can be said that particles with different optical properties are progressing from right to left at this time and, the smaller the gradient, the faster the flow rate is. Conversely, when the locus of the dense pixels falls to the right, it can be said that the particles with different optical properties are flowing in the reverse direction from left to right at this time. In FIG. 7, an aspect in which a fluid is temporarily flowing in the reverse direction is shown.

Further, because the frictional drag between the particles with different optical properties and the fluid medium is generally large, a plurality of particles with different optical properties are translated without there being a change in their position relative to one another. Thus, in the case of image A which is displayed such that image pickup images of a plurality of times can be compared, the flow state of the fluid in the translucent duct 10 can be visually grasped and it is easy to grasp the flow state even when same is complex. Therefore, optimization of the control timing and so forth of the actuator can also be performed. Further, in image A, the amounts of light received by the CCD elements may be expressed using gray scales or the image output circuit 54 may carry out binarization by applying a predetermined threshold value.

### (D) Fourth Embodiment

In the first embodiment, it was possible to measure the flow rate and flow volume and so forth with favorable responsiveness and specify an instantaneous flow rate and flow volume at the respective times. However, in the case of an intermittent flow as shown in image A of FIG. 7, there was the problem that the flow rate became unstable and ripples had an adverse effect on the instantaneous flow rates and flow volumes. In other words, in the case of an intermittent flow for which the flow rate is unstable, the average flow rate and flow volume over a long period is preferably calculated when grasping the flow state. For example, it may be said that it is more important to obtain the average flow rate from time t1 to time t5 than the flow rate from time t1 to time t2 in image A of FIG. 7 after considering the total amount of fluid supplied.

The average flow rate from time t1 to time t5 can be obtained by dividing the distance (number of pixels) that the particles with different optical properties have moved from time t1 to time t5 by the time from time t1 to time t5 and applying the optical imaging magnification of the CCD line sensor 42. The distance (number of pixels) that the particles with different optical properties have moved from time t1 to time t5 is specified using the translational properties of the particles with different optical properties. The technique for calculating the distance that the particles with different optical properties have moved from time t1 to time t5 will be explained hereinbelow.

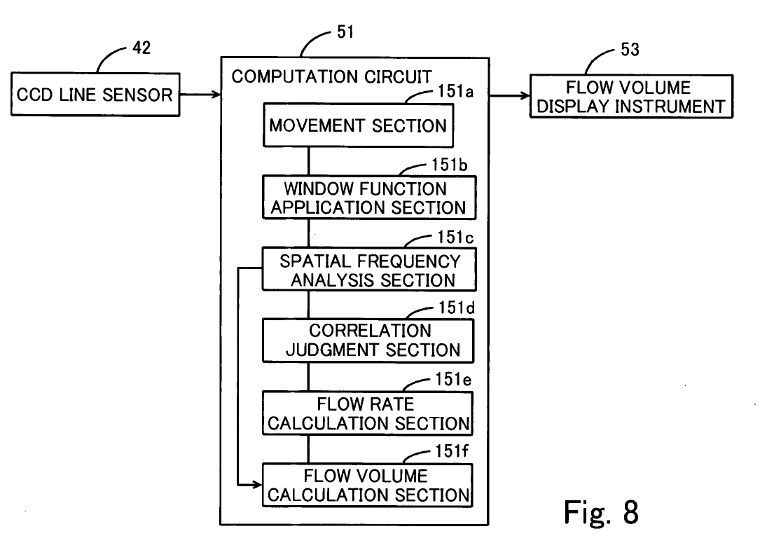

FIG. 8 shows an exemplary constitution for calculating the flow rate from the image pickup images picked up by the CCD line sensor 42. In FIG. 8, the computation circuit 51 obtains the image pickup images from the CCD line sensor 42. The computation circuit 151 replaces the spatial filter computation circuit 51 of the first embodiment and is constituted by a movement section 151a, a window function application section 151b, a spatial frequency analysis section 151c, a correlation judgment section 151d, a flow rate calculation section 151e, and a flow volume calculation section 151f. The movement section 151a, window function application section 151b, and spatial frequency analysis section 151c correspond to the spatial frequency analysis means of the present invention and the correlation judgment section 151d and flow rate calculation section 151e correspond to the flow rate calculation means of the present invention. First, the computation circuit 51 acquires the image pickup images picked up at different times and the image pickup times. For example, the computation circuit 51 acquires the respective image pickup images at times t1 and t5 in image A of FIG. 7.

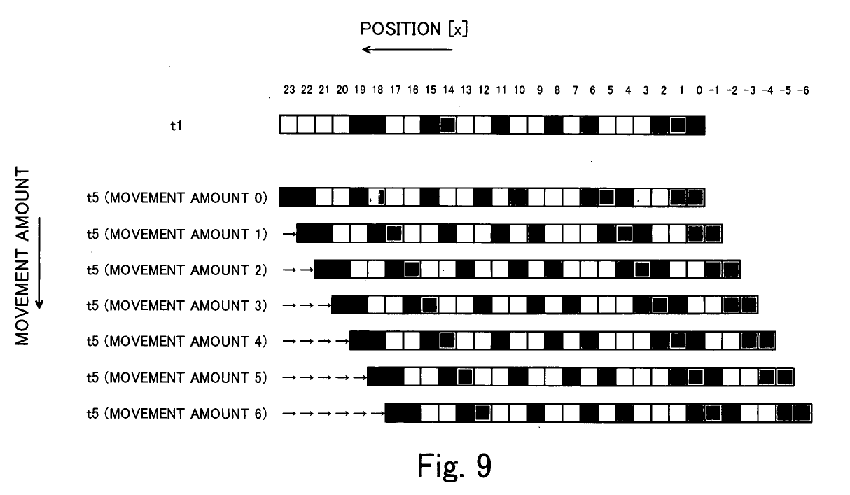

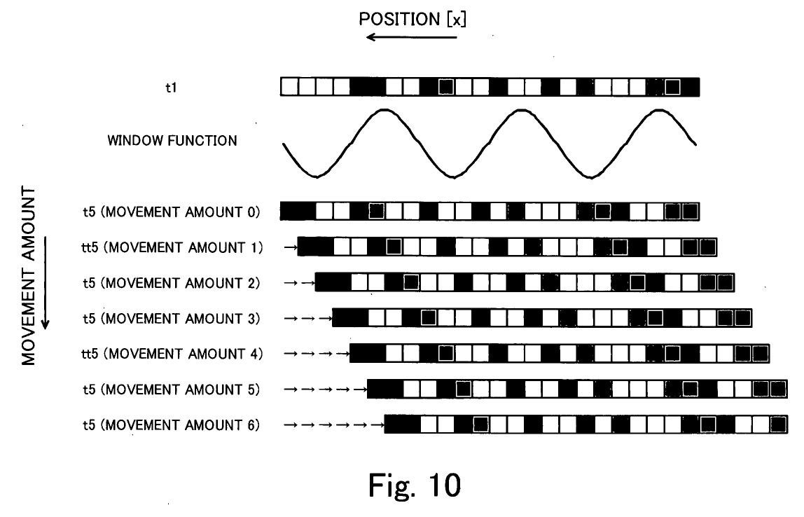

The movement section 151a shifts the image pickup images picked up at time t5 in the axial core direction. FIG. 9 schematically shows an exemplary aspect in which the movement section 151a shifts the image pickup images picked up at time t5 in the axial core direction. In FIG. 9, the image pickup images picked up at time t5 are shifted to the right of the page. In FIG. 9, image pickup images that have been moved with movement amounts of 0 to 6 pixels are illustrated. That is, when the movement amount is n pixels, the position x in the axial core direction of the horizontal axis is shifted to (x-n). The window function application section 151b multiplies the image pickup images by a sine function as the window function. FIG. 10 shows an exemplary comparison between the window function and the respective pixel images. The window function M(x) shown in FIG. 10 can be expressed by the following equation:

In other words, the window function M(x) is an 8-pixel cycle sine wave. Further, the window function M(x) is only an example and can be suitably changed in accordance with the resolution and so forth of the CCD line sensor 42. The window function application section 151b multiplies the brightness B(x) of each pixel by the window function M(x). As a result, the brightness B(x) of each pixel is cyclically enhanced by the window function M(x).

The image pickup images picked up at time t5 is multiplied by the window function M(x) and an image pickup image enhanced by the window function M(x) is obtained. Likewise, the image pickup images picked up at time t5 that have been moved by the movement section 151a are also multiplied by the window function M(x), and enhanced image pickup images are obtained. However, because the image pickup images picked up at time t5 are moved by the movement section 151a, the relative phases in the axial core direction of the brightness B(x) and window function M(x) of each pixel are shifted and multiplied. Further, image pickup images and the window function M(x) for time t5 can also be moved relatively in the axial core direction and a plurality of window functions M(x) the initial phase angle of which is shifted may be prepared multiplied by the brightness B(x) of the respective pixels at time t5. Further, the image pickup images at times t1 and t5 may be moved relatively in the axial core direction or the image pickup images at time t5 may be fixed and the image pickup images at time t1 may be moved.

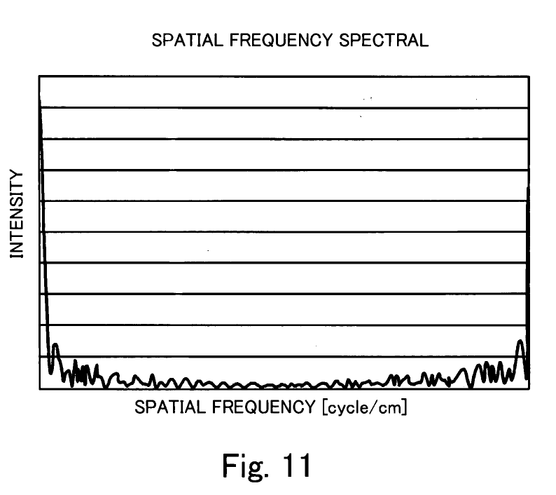

The spatial frequency analysis section 151c performs a high-speed Fourier transform (abbreviated as ‘FFT’ hereinbelow) with respect to image pickup images picked up at time t1 and enhanced by the window function M(x). FIG. 11 shows an exemplary spatial frequency spectral of the image pickup images at time t1 that was obtained by the FFT transform. In FIG. 11, the horizontal axis represents the spatial frequency f and the vertical axis represents the intensity (corresponds to an integrated value of the amplitudes of the respective luminance waves). Further, FIGS. 8 to 10 show a simplified version of the image pickup images. A variety of luminance waves can be sensed as shown in FIG. 11 at the actual resolution of the CCD line sensor 42.

The spatial frequency analysis section 151c performs an FFT transform on the respective image pickup images picked up at time t5 and enhanced by the window function M(x) the phase of which is displaced. As a result, a spatial frequency spectral can be obtained for the respective image pickup images picked up at time t5 and moved by 0 to 6 pixels. The correlation judgment section 151d evaluates the correlation between the spatial frequency spectral related to the image pickup images at time t 1 and the spatial frequency spectral related to the respective image pickup images at time t5 (with movement amounts of 0 to 6 pixels). More specifically, the correlation coefficient W(XY) is calculated by means of the following equation:

In the above equation, f is the spatial frequency and * represents a complex product. Further, X(f) is the intensity of the spatial frequency spectral of the image pickup images picked up at time t1 and Y(f)* represents the conjugate of the intensity of the spatial frequency spectrals of the image pickup images picked up at time t5. Seven different correlation coefficients W(XY) are calculated using the equation above in correspondence with pixels of movement amounts 0 to 6. The correlation judgment section 151d detects the movement amount with the largest correlation coefficient W(XY) and outputs this movement amount to the flow rate calculation section 1S 1e.

Here, the relative position of the window function M(x) fluctuates in accordance with the amounts by which the image pickup images picked up at time t5 are moved by the movement section 151a and spatial frequency spectrals of different inclinations are obtained in accordance with these movement amounts. Furthermore, because particles with different optical properties move to different positions as time elapses also for the image pickup images picked up at different times, a relative displacement with respect to the window function M(x) is produced and spatial frequency spectrals of essentially different inclinations are obtained. Hence, spatial frequency spectrals that are obtained from image pickup images picked up at times t1 and t5 also represent inclinations that are essentially different.

However, only in cases where the movement section 151a has moved the image pickup images at time t5 so that the distances by which the particles with different optical properties move between time t1 and time t5 cancel each other out, the positions in the axial core direction of the image pickup images of times t1 and t5 coincide and, as a result, the relative positions in the axial core direction with respect to the window function M(x) also coincide for both image pickup images. In this case, the spatial frequency spectrals obtained from the image pickup images of times t1 and t5 have the same inclination and represent a high correlation coefficient W(XY). FIG. 10 shows that, when the image pickup images picked up at time t5 have been moved by four pixels, movement is performed such that the distances by which the particles with different optical properties move between times t1 and t5 cancel each other out and the brightness B(x) of each pixel has been similarly enhanced by the window function M(x). The relative movement amount for which the correlation coefficient W(XY) is highest as described earlier can be said to correspond to the distance by which the particles with different optical properties have moved between times t1 and t5.

When the movement amount for which the correlation function W(XY) between the spatial frequency spectrals of the image pickup images picked up at different times is largest is specified, the flow rate calculation section 151e that acquires this movement amount calculates the flow rate on the basis of the movement amount. As mentioned earlier, the movement amount for which the correlation function W(XY) is highest corresponds to the distance by which the particles with different optical properties have moved between times t1 and t5, the pixel movement amount per unit of time can be specified by dividing the distance by the time (t5−t1). Ultimately, the flow rate of the actual axial core can be obtained by dividing the pixel movement amount per unit of time by the optical imaging magnification m. As long as the flow rate of the axial core is obtained, the average flow rate can be calculated by means of the same technique as that of the first embodiment.

The average flow rate calculated by the flow rate calculation section 151e is output to the flow volume calculation section 151f. The flow volume calculation section 151f inputs the spatial frequency spectral of the image pickup images at time t1 from the spatial frequency analysis section 151c and calculates (integrates) the product sum of the intensity of the spatial frequency spectral with respect to the spatial frequency. As mentioned earlier, because the intensity of the spatial frequency spectral corresponds to the integrated value of the amplitudes of the respective luminance waves, the integrated value of the intensity is a value that corresponds to the scattered light amount that enters the CCD line sensor 42. That is, by integrating the intensity of the spatial frequency spectral, the total amount of scattered light entering the CCD line sensor 42 can be obtained.

As mentioned in the second embodiment, there is an unambiguous relationship between the scattered light amount scattered in the translucent duct 10 and the density of the unsaturated fluid flowing in the translucent duct 10. Hence, the flow volume calculation section 151f is able to estimate the density of the unsaturated fluid flowing in the translucent duct 10 by taking the integrated value of the intensity of the spatial frequency spectral as an index value. For example, the relationship between the integrated value of the intensity and the density of the unsaturated fluid is examined beforehand by means of an experiment, a table or the like is prepared, and the density of the unsaturated fluid can be estimated by referencing the table. As long as the density of the unsaturated fluid can be estimated, the average flow volume from time t1 to time t5 can be specified by multiplying the density by the average flow rate.

### (E) SUMMARY

As described hereinabove, Based on the reality that even when a fluid is uniform and does not appear to produce scattered light, there are no fluids that are actually homogeneous and in which particles with different properties do not exist, when laser light is made to pass through a translucent duct and condensed to extend in the length direction in an axial core area of a predetermined region of the transmission path, image pickup can be performed by the CCD line sensor 42 as a result of scattered light being produced by particles with different properties in the axial core area and a velocity component that uses a spatial filter can be computed by performing a predetermined operation. Moreover, the average flow rate and flow volume and so forth can be determined on the basis of the laminar flow in the translucent duct 10.

Although the invention has been described in considerable detail in language specific to structural features or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. For example, the inductors can be hollow tubular coils. Such variations and alternate embodiments are contemplated, and can be made without departing from the spirit and scope of the invention.

It is to be understood that the phraseology and terminology employed herein, as well as the abstract, are for the purpose of description and should not be regarded as limiting.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A device for observing a flow state, comprising:
a translucent duct;
an irradiation unit irradiating projection light;
a condensing unit condensing the projection light along a length direction with respect to an axial core area of the translucent duct in which a fluid flows; and
an image pickup unit for picking up images of scattered reflected light from an axial core area of the translucent duct at a plurality of times.

2. A device for observing a flow state as set forth in claim 1, further comprising:
a computation unit for calculating a flow rate of the fluid on the basis of the image at the plurality of times.

3. A device for observing a flow state as set forth in claim 2, wherein:
the fluid is a saturated fluid that flows in the duct and a flow volume of the saturated fluid is calculated on a basis of the flow rate and a cross-sectional area of the duct.

4. A device for observing a flow state as set forth in claim 2, wherein:
the fluid is an unsaturated fluid that flows in the duct and a flow volume of the unsaturated fluid is calculated on a basis of the flow rate and an attenuation volume of a transmitted light that is transmitted via the translucent duct.

5. A device for observing a flow state as set forth in claim 2, wherein:
the fluid is an unsaturated fluid that flows in the duct and a flow volume of the unsaturated fluid is calculated on a basis of the flow rate and a scattered light amount scattered in the translucent duct.

6. A device for observing a flow state as set forth in claim 1, wherein:
the irradiation unit comprises a semiconductor laser and a Pulse Width Modulation (PWM) control circuit that controls an output of the semiconductor laser.

7. A device for observing a flow state as set forth in claim 1, wherein:
the image pickup unit comprises a Charge Coupled Device (CCD) line sensor.

8. A device for observing a flow state as set forth in claim 7, wherein:
a computation unit applies a spatial frequency filter to the image pickup images picked up by the CCD line sensor.

9. A device for observing a flow state as set forth in claim 7, wherein:
a computation unit multiplies a weighting function as a spatial frequency filter to outputs of the CCD line sensor.

10. A device for observing a flow state as set forth in claim 7, wherein:
a computation unit multiplies a sine function as a weighting function.

11. A device for observing a flow state as set forth in claim 9, wherein:
a computation unit multiplies a rectangular wave function as a weighting function.

12. A device for observing a flow state as set forth in claim 1, wherein:
the image pickup is performed by mixing particles of different optical properties that increase the scattered reflected light of the projection light with the fluid.

13. A device for observing a flow state as set forth in claim 1, wherein:
the image pickup unit is disposed in a direction in which a reflected light component from the translucent duct is large.

14. A device for observing a flow state as set forth in claim 1, further comprising:
an output unit for visually outputting the images at a plurality of times.

15. A device for observing a flow state as set forth in claim 7, further comprising:
a spatial frequency analysis unit for acquiring the images picked up by the CCD line sensor that are picked up at different times and for acquiring a spatial frequency spectral that relates to the axial core direction of the images while moving the images relatively in the axial core direction; and
a flow rate calculation unit for calculating the flow rate of the fluid on the basis of a relative movement amount of the image pickup images when a correlation between the images and the spatial frequency spectral is enhanced.

16. A device for observing a flow state as set forth in claim 15, wherein:
the spatial frequency analysis unit multiplies a window function obtained by shifting a relative position in the axial core direction with respect to the images.

17. A device for observing a flow state as set forth in claim 16, wherein:
the spatial frequency analysis unit multiplies a sine function as the window function.

18. A device for observing a flow state as set forth in claim 17, wherein:
the fluid is an unsaturated fluid that flows in the duct and the flow volume of the unsaturated fluid is estimated on a basis of an index value obtained by multiplying together a value obtained by integrating an intensity of the spatial frequency spectral and the flow rate.

19. A method for observing a flow state, comprising:
condensing projection light at an axial core of a translucent duct; and
performing image pickup on an axial core area at a plurality of times.
